(19) United States
(12) Patent Application Publication
(10) Pub. No.: US 2019/0232755 A1
(43) Pub. Date: Aug. 1, 2019

(54) HVAC AIR INTAKE

(71) Applicant: Valeo Climate Control Corp., Auburn Hills, MI (US)

(72) Inventors: Earl Buckman, Warren, MI (US); Darshan Parikh, Farmington Hills, MI (US); Steven Marshall, Oxford, MI (US)

(21) Appl. No.: 16/260,013

(22) Filed: Jan. 28, 2019

Related U.S. Application Data
(60) Provisional application No. 62/623,261, filed on Jan. 29, 2018.

(51) Int. Cl. B60H 1/00; B60H 1/32

(52) U.S. Cl. CPC B60H 1/00849; B60H 1/00735; B60H 2001/00085; B60H 1/00028; B60H 1/3205

(57) ABSTRACT

An HVAC air intake for a vehicle, includes an air intake housing disposed outside of a passenger compartment of the vehicle. A fresh air inlet is defined in an upper portion of the air intake housing. A drain is disposed in a sump portion of the air intake housing to drain water from the sump portion. A recirculation door is disposed in a recirculation airflow doorway defined in the air intake housing below the fresh air inlet and above the sump portion. The recirculation door prevents air from flowing upwardly, and water from flowing downwardly through the recirculation airflow doorway when the recirculation door is closed. A conduit is disposed in the air intake housing to convey water from the upper portion of the air intake housing, around the recirculation door, to the sump portion when the recirculation door is closed.

### CROSS-REFERENCE TO RELATED APPLICATION

This application claims the benefit of U.S. provisional application Ser. No. 62/623,261, filed Jan. 29, 2018, which is incorporated herein by reference in its entirety.

### BACKGROUND

HVAC (Heating Ventilation and Air Conditioning) systems are used for climate control of, e.g., internal cabin areas of an automobile. HVAC systems may be configured with an HVAC module having a heat exchanger disposed in a housing. An HVAC distribution system may be operatively connected to the HVAC module. An HVAC system may have one or more airflow paths for allowing air to flow, for example, to, from, and/or within the HVAC module and the HVAC distribution system. An HVAC air intake housing may be connected to a blower of the HVAC module.

### SUMMARY

An HVAC air intake for a vehicle includes an air intake housing disposed outside of a passenger compartment of the vehicle. A fresh air inlet is defined in an upper portion of the air intake housing. A drain is disposed in a sump portion of the air intake housing to drain water from the sump portion. A recirculation door is disposed in a recirculation airflow doorway defined in the air intake housing below the fresh air inlet and above the sump portion. The recirculation door prevents air from flowing upwardly, and water from flowing downwardly through the recirculation airflow doorway when the recirculation door is closed. A conduit is disposed in the air intake housing to convey water from the upper portion of the air intake housing, around the recirculation door, to the sump portion when the recirculation door is closed.

### INTRODUCTION

A first aspect disclosed herein is an HVAC air intake for a vehicle, comprising: an air intake housing disposed outside of a passenger compartment of the vehicle; a fresh air inlet defined in an upper portion of the air intake housing; a drain disposed in a sump portion of the air intake housing to drain water from the sump portion; a recirculation door disposed in a recirculation airflow doorway defined in the air intake housing below the fresh air inlet and above the sump portion, wherein the recirculation door is to prevent air from flowing upwardly, and water from flowing downwardly, through the recirculation airflow doorway when the recirculation door is closed; and a conduit disposed in the air intake housing to convey water from the upper portion of the air intake housing, around the recirculation door, to the sump portion when the recirculation door is closed.

In an example of this first aspect, the air intake housing is connected to an intake side of a blower. In an example, the recirculation door is to selectably open a recirculation airflow path to selectably admit air from the passenger compartment into the recirculation airflow path, the air to flow to the intake side of the blower via the recirculation airflow path.

In an example of this first aspect, the conduit is defined by an exterior wall of the air intake housing and an interior wall located within a volume enclosed by the air intake housing, the interior wall being spaced apart from the exterior wall. In an example, the interior wall is co-molded with the air intake housing. In an example, the interior wall is attached to the air intake housing.

In an example of this first aspect, the conduit is a recirculation door bypass tube.

In an example of this first aspect, the HVAC air intake further comprises a normally closed check valve in fluid communication with the drain to open when water is present on an input side of the normally closed check valve

In an example of this first aspect, the HVAC air intake further comprises a screen disposed in contact with the drain, wherein the screen has screen openings smaller than a minimum size, the screen to hinder entry of objects and organisms through the drain into the HVAC air intake.

It is to be understood that any features of the HVAC air intake disclosed herein may be combined together in any desirable manner and/or configuration.

A second aspect disclosed herein is an HVAC system for a vehicle, comprising: an HVAC module having a heat exchanger disposed in an HVAC module housing, the HVAC module disposed in a passenger compartment of the vehicle; a blower disposed in the HVAC module; and an HVAC air intake in fluid communication with the HVAC module, the HVAC air intake including: an air intake housing disposed outside of the passenger compartment of the vehicle, the air intake housing connected to an intake side of the blower; a fresh air inlet defined in an upper portion of the air intake housing; a drain disposed in a sump portion of the air intake housing to drain water from the sump portion; a recirculation door disposed in a recirculation airflow doorway defined in the air intake housing below the fresh air inlet and above the sump portion to selectably open a recirculation airflow path to selectably admit air from the passenger compartment into the recirculation airflow path, the air to flow to the intake side of the blower via the recirculation airflow path, wherein the recirculation door is to prevent air from flowing upwardly, and water from flowing downwardly, through the recirculation airflow doorway when the recirculation door is closed; and a conduit disposed in the air intake housing to convey water from the upper portion of the air intake housing, around the recirculation door to the sump portion when the recirculation door is closed.

In an example of this second aspect, the conduit is defined by an exterior wall of the air intake housing and an interior wall located within a volume enclosed by the air intake housing, the interior wall being spaced apart from the exterior wall.

In an example of this second aspect, the conduit is a recirculation door bypass tube.

It is to be understood that any features of the HVAC system disclosed herein may be combined together in any desirable manner and/or configuration.

A third aspect disclosed herein is a method of making an HVAC air intake, comprising: molding an air intake housing, wherein a fresh air inlet is defined in an upper portion of the air intake housing, and a drain is disposed in a sump portion of the air intake housing to drain water from the sump portion; and attaching a recirculation door in a recirculation airflow doorway defined in the air intake housing below the fresh air inlet and above the sump portion, wherein the recirculation door is to selectably open a recirculation airflow path to selectably allow air from a passenger compartment of a vehicle to flow to an intake side of a blower, wherein the recirculation door is to prevent air from flowing upwardly, and water from flowing downwardly, through the recirculation airflow doorway when the recirculation door is closed, wherein the air intake housing has a conduit to convey water from the upper portion of the air intake housing, around the recirculation door to the sump portion when the recirculation door is closed; wherein the HVAC air intake is to be installed outside of the passenger compartment of the vehicle and wherein the air intake housing is to be connected to the intake side of a blower.

In an example of this third aspect, the method further comprises: molding an interior wall with an exterior wall of the air intake housing, wherein the conduit is defined by the exterior wall of the air intake housing and the interior wall, wherein the interior wall is located within a volume enclosed by the air intake housing, and wherein the interior wall is spaced apart from the exterior wall.

In an example of this third aspect, the method further comprises: attaching the conduit to an interior of the air intake housing, wherein the conduit is a recirculation door bypass tube.

It is to be understood that any features of the method disclosed herein may be combined together in any desirable manner and/or configuration.

Further, it is to be understood that any combination of features of any aspect of the HVAC air intake and/or of any aspect of the HVAC system and/or of any aspect of the method of making an HVAC air intake may be used and/or combined together in any desirable manner, and/or may be used and/or combined with any of the examples disclosed herein.

### BRIEF DESCRIPTION OF THE DRAWINGS

Features of examples of the present disclosure will become apparent by reference to the following detailed description and drawings, in which like reference numerals correspond to the same or similar, though perhaps not identical, components. For the sake of brevity, reference numerals or features having a previously described function may or may not be described in connection with other drawings in which they appear.

FIG. 1 is a semi-schematic cross-sectional side view of an HVAC system for a vehicle according to an example of the present disclosure showing a potential pooling location where water may pool without the conduit of the present disclosure;

FIG. 2 depicts airflow with an example of the HVAC system as disclosed herein operating in a combined recirculation mode and fresh air mode according to the present disclosure;

FIG. 3 is a semi-schematic perspective view of an example of an HVAC air intake according to the present disclosure;

FIG. 4A is a semi-schematic cross-sectional side view of an HVAC system for a vehicle according to an example of the present disclosure showing where water can drain through the conduit in an example of the present disclosure;

FIG. 4B is a detailed portion of the semi-schematic cross-sectional side view shown in FIG. 4A showing where water can drain through an example of the conduit in an example of the present disclosure;

FIG. 5 is a semi-schematic cross-sectional side view of an example of an HVAC air intake connected to a blower according to the present disclosure;

FIG. 6 is a semi-schematic side view of an example of an HVAC system housing connected to a blower according to the present disclosure;

FIG. 7 is a semi-schematic perspective cutaway view of an example of an air inlet housing connected to a blower according to the present disclosure; and

FIG. 8 is a flow chart depicting an example of a method of making an HVAC intake according to the present disclosure.

### DETAILED DESCRIPTION

Space in the passenger compartment of an automobile may be used, among other purposes, for devices to control of the vehicle; and for passenger entertainment and comfort-promoting devices. Electrification of vehicles has contributed new and additional equipment to be accommodated within the passenger compartment space. Space in the passenger compartment available for accommodating passengers and for other purposes may be increased by combining a fresh air inlet and a recirculation air inlet outside of the passenger compartment as disclosed herein. Examples of the present disclosure provide an escape path for water in the air intake and allow packaging of the fresh air inlet under the hood.

As used herein, a “passenger compartment” of a vehicle means an enclosable space for human beings to occupy when the vehicle is moving. In this context, the passenger compartment may be sized such that an operator, or driver, is the only occupant of the vehicle when the vehicle is moving. In this case, the driver is also considered a passenger. Some vehicles may not require an operator/driver to occupy the vehicle, e.g., remotely operated vehicles and automatic vehicles. As used herein, the passenger compartment of the vehicle is enclosable. For example, doors, windows, a roof, and a floor may enclose the passenger compartment. Herein, the bed of a pickup truck is not considered a part of a passenger compartment. In a typical three-box vehicle, for example, a sedan, there may be an engine compartment, a passenger compartment, and a cargo compartment. In certain vehicles, sometimes called two-box vehicles, e.g., station wagons or some passenger vans, the passenger compartment may be combined with the cargo compartment. Some vehicles may not have an engine, therefore, the “engine compartment” may not exist, or may have a different purpose. Some engine compartments are located at the front of a vehicle and are relatively open to the atmosphere. Other engine compartments are at the rear of their respective vehicles. In some vehicles, a bulkhead is a common wall separating the passenger compartment from the engine compartment or other compartment immediately adjacent to the passenger compartment in the vehicle. In some vehicles, the floorpan is stamped or otherwise formed to define at least part of the bulkhead.

As used herein, “fresh air” means air that is drawn into the HVAC system 10 or air intake housing 14 from outside of the passenger compartment of the vehicle. It is to be understood that “fresh air” may include constituents found in an atmosphere surrounding the vehicle, and is therefore not necessarily clean air. Fresh air is distinguished from recirculated air that is drawn into the HVAC system or air intake housing 14 from the passenger compartment. In examples of the present disclosure, a replaceable filter 47 may be installable in the air intake housing 14.

Fresh air intake is a typical function of an automotive HVAC unit. The passenger compartment of a vehicle is typically capable of being isolated from the environment external to the passenger compartment. For example, the passenger compartment may be protected from rain, wind, and road splash, and be kept within a comfortable temperature range. In examples of the present disclosure, an air inlet may be packaged outside of the passenger compartment, in the front portion of the vehicle (e.g. the engine compartment). Some water (e.g. from rain, road splash, automatic car wash, snow melt, etc.) may occasionally enter into the air intake along with fresh air. In some instances, some water may enter into the fresh air inlet by gravity or momentum (e.g., runoff, ice/snow melt, splash), that is, without being carried along with fresh air.

Examples of the present disclosure advantageously allow water that may accumulate when the HVAC system is operating in recirculation mode to drain outside of the passenger compartment. As disclosed herein, an air inlet provides an escape path for water that may otherwise accumulate in the air intake housing when the HVAC system is operating in the recirculation mode.

In examples of the present disclosure, the HVAC system has a blower with an intake side and a discharge side. The HVAC system may have a first operating mode, which may also be known as a normal operating mode, in which all of the air entering the intake side of the blower is fresh air. In some vehicles, air extractors allow some of the air in the passenger compartment to vent to prevent pressurization of the passenger compartment when the HVAC system blows fresh air into the passenger compartment. Thus, some of the energy that has been put into conditioning (i.e., heating, cooling, and/or dehumidifying) the air in the passenger compartment is lost due to venting and leakage. It is to be understood, however, that fresh air may be desirable for comfort of the occupants of the passenger compartment; therefore, at least some venting and leakage is not necessarily undesirable. In the recirculation mode of operating a vehicle HVAC system, some of the air from the passenger compartment is drawn out of the passenger compartment and conveyed to the intake side of the blower. The recirculation mode may save energy and, in some instances, reduce the time for the air in the passenger compartment to stabilize at a comfortable temperature. In examples of the present disclosure, the proportion of fresh air to recirculated air entering the blower may be any desirable proportion. In at least one mode disclosed herein, none of the passenger air is recirculated. In this mode, a recirculation door closes a recirculation airflow doorway and blocks a recirculation airflow path between the passenger compartment and the intake side of the blower. When the recirculation door is open, some of the water that enters the fresh air inlet can drain to the sump through the recirculation airflow doorway. When the recirculation door is closed, water is blocked from flowing through the recirculation airflow doorway. In examples of the present disclosure, a conduit is disposed in the air intake housing to convey water from the upper portion of the air intake housing, around the recirculation door, to the sump portion of the air intake housing.

Examples of the present disclosure include an HVAC air intake with a conduit that provides a path to allow water to escape from the air intake and flow to a space out of the passenger compartment. Examples of the present disclosure may be used for an air intake that is packaged outside the passenger compartment where there may be potential for water entering the air intake. Water is allowed to flow out of the air intake housing without entering the passenger compartment.

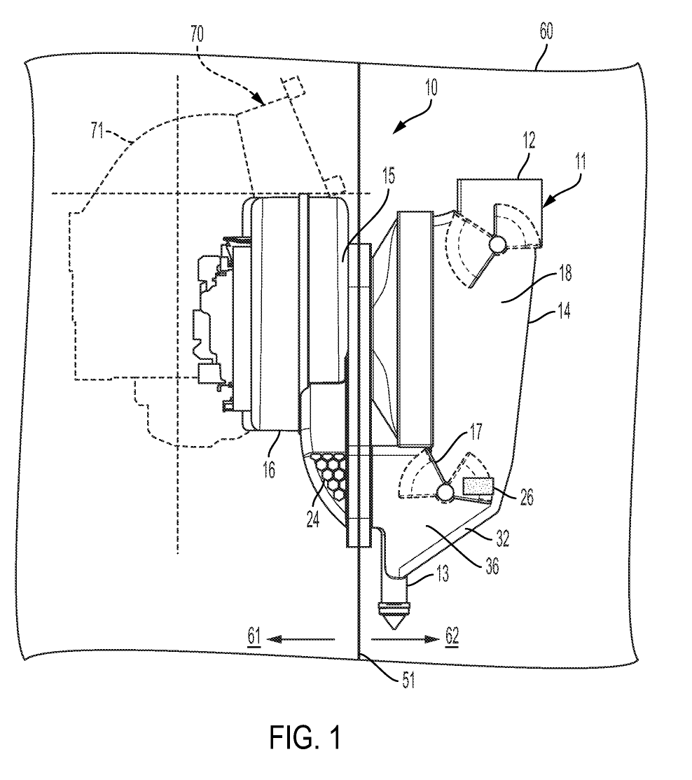

FIG. 1 is a semi-schematic cross-sectional side view of an HVAC system 10 for a vehicle 60 according to an example of the present disclosure showing a potential pooling location 26 where water may pool without the conduit 32 of the present disclosure. In examples as depicted in FIG. 1, the HVAC system 10 includes an HVAC module 70 having a heat exchanger (not shown) disposed in an HVAC module housing 71. The HVAC module 70 is disposed in a passenger compartment 61 of the vehicle 60. As shown in FIG. 1, the passenger compartment 61 is to the left of the bulkhead 51; and the engine compartment 62 is to the right of the bulkhead 51. The HVAC system 10 includes a blower 16 disposed in the HVAC module 70. The HVAC system 10 further includes an HVAC air intake 11 in fluid communication with the HVAC module 70. The HVAC air intake 11 includes an air intake housing 14 disposed outside of the passenger compartment 61 of the vehicle 60. The air intake housing 14 is connected to an intake side 15 of the blower 16. The HVAC air intake 11 includes a fresh air inlet 12 defined in an upper portion 18 of the air intake housing 14. The upper portion 18 of the air intake housing 14 means the portion of the air intake housing above the recirculation door 17 when the recirculation door 17 is in a closed position. In FIG. 1, the recirculation door 17 is shown in the fully open position in phantom line. The HVAC air intake 11 includes a drain 13 disposed in a sump portion 36 of the air intake housing 14 to drain water from the sump portion 36. As used herein, the sump portion 36 means the portion of the air intake housing below the recirculation door 17 when the recirculation door 17 is in the closed position.

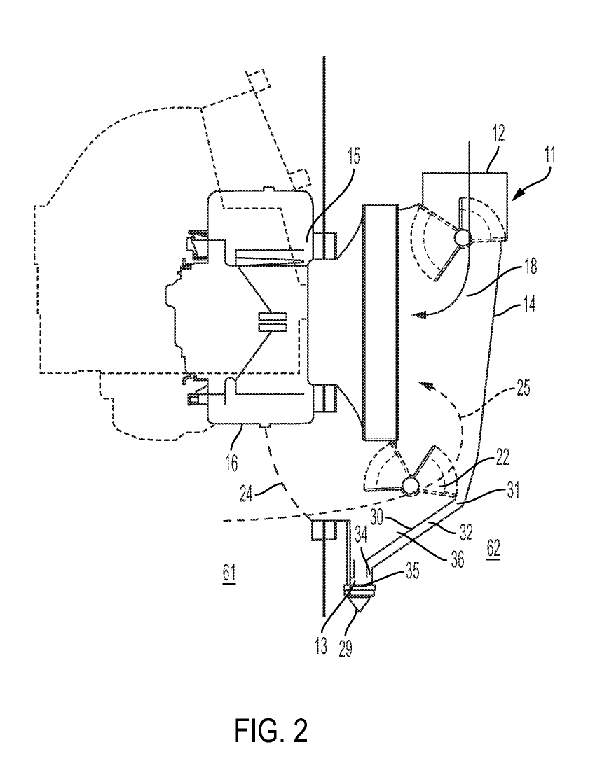

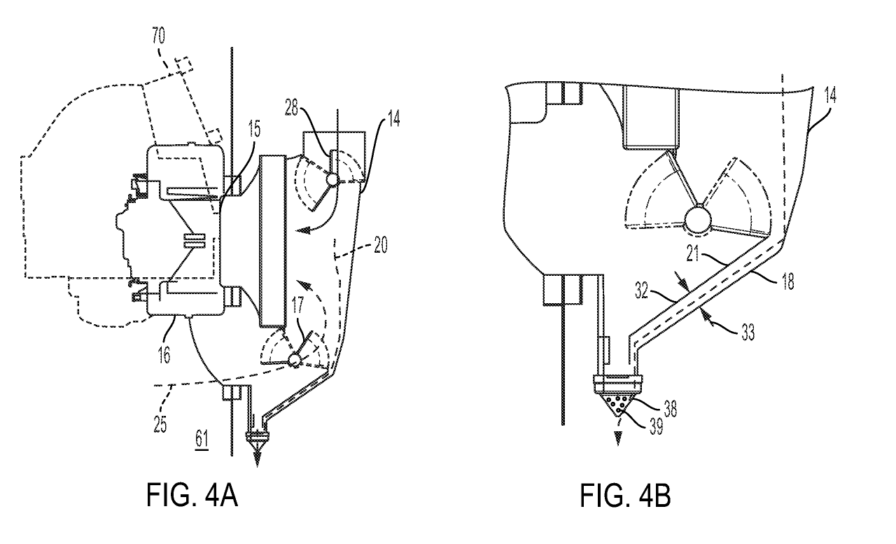

FIG. 2 depicts airflow with the HVAC system 10 operating in a combined recirculation mode and fresh air mode. The fresh air door 28 (upper door in FIG. 2, also shown, e.g., in FIG. 4A) is open and fresh air is drawn through the fresh air inlet 12 into the air intake housing; while the recirculation door 17 is also open and recirculated air is drawn through the recirculation screen 24 into the air intake housing 14. The fresh air and recirculated air are combined in the air intake housing 14 and enter the blower 16 at the intake side 15 of the blower 16.

In examples, the HVAC air intake 11 includes a recirculation door 17 disposed in a recirculation airflow doorway 22 defined in the air intake housing 14 below the fresh air inlet 12 and above the sump portion 36 to selectably open a recirculation airflow path 25 to selectably admit air from the passenger compartment 61 into the recirculation airflow path 25. The air in the HVAC air intake 11 is to flow to the intake side 15 of the blower 16 via the recirculation airflow path 25. The recirculation door 17 is to prevent air from flowing upwardly, and water from flowing downwardly, through the recirculation airflow doorway 22 when the recirculation door 17 is closed (see, e.g., FIG. 4B). The HVAC air intake 11 includes a conduit 32 disposed in the air intake housing 14 to convey water from the upper portion 18 of the air intake housing 14, around the recirculation door 17 to the sump portion 36 when the recirculation door 17 is closed (see, e.g., FIG. 4B).

In examples of the present disclosure, an HVAC air intake 11 for a vehicle 60 includes an air intake housing 14 disposed outside of a passenger compartment 61 of the vehicle 60. In some examples, the air intake housing 14 is disposed in an engine compartment 62 of the vehicle 60. In examples of the present disclosure, the air intake housing 14 may be disposed in any compartment of a vehicle 60 that is immediately adjacent to the passenger compartment 61 and that has exposure to water during operation of the vehicle 60. Exposure to water means that the compartment has at least one opening that will allow water to enter the compartment. The water may be rain, road splash, spray from a car wash, or any source of water. Exposure to water also includes exposure to snow and ice.

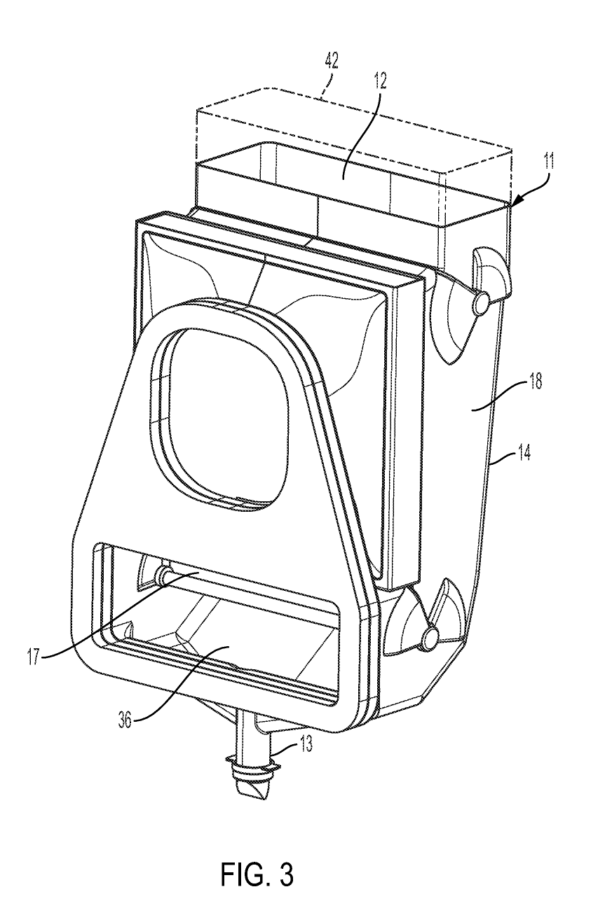

FIG. 3 is a semi-schematic perspective view of an example of an HVAC air intake 11 according to the present disclosure. In examples of the present disclosure, the HVAC air intake 11 includes a fresh air inlet 12 defined in an upper portion 18 of the air intake housing 14. A drain 13 is disposed in a sump portion 36 of the air intake housing 14 to drain water from the sump portion 36. A recirculation door 17 is disposed in a recirculation airflow doorway 22 defined in the air intake housing 14 below the fresh air inlet 12 and above the sump portion 36. The recirculation door 17 is to prevent air from flowing upwardly, and water from flowing downwardly, through the recirculation airflow doorway 22 (see FIG. 2) when the recirculation door 17 is closed. A conduit 32 (see FIG. 2) is disposed in the air intake housing 14 to convey water from the upper portion 18 of the air intake housing 14, around the recirculation door 17, to the sump portion 36 when the recirculation door 17 is closed.

As depicted in FIG. 4A and FIG. 4B, in some examples, the air intake housing 14 may be connected to an intake side 15 of a blower 16. The recirculation door 17 may be to selectably open a recirculation airflow path 25 to selectably admit air from the passenger compartment 61 into the recirculation airflow path 25, the air to flow to the intake side 15 of the blower 16 via the recirculation airflow path 25. In FIG. 4B, the recirculation door 17 is shown in solid line in the closed position; and the fully open position for the recirculation door 17 is shown in phantom lines. In FIG. 4A, the recirculation door 17 and the fresh air door 28 are shown in solid lines in the respective fully open positions, and in respective closed positions in dashed lines. In FIG. 4A, a water flow path 20 is shown running through the conduit 32; however, it is to be understood that water may flow through the recirculation airflow doorway 22 when the recirculation door 17 is in the fully open position.

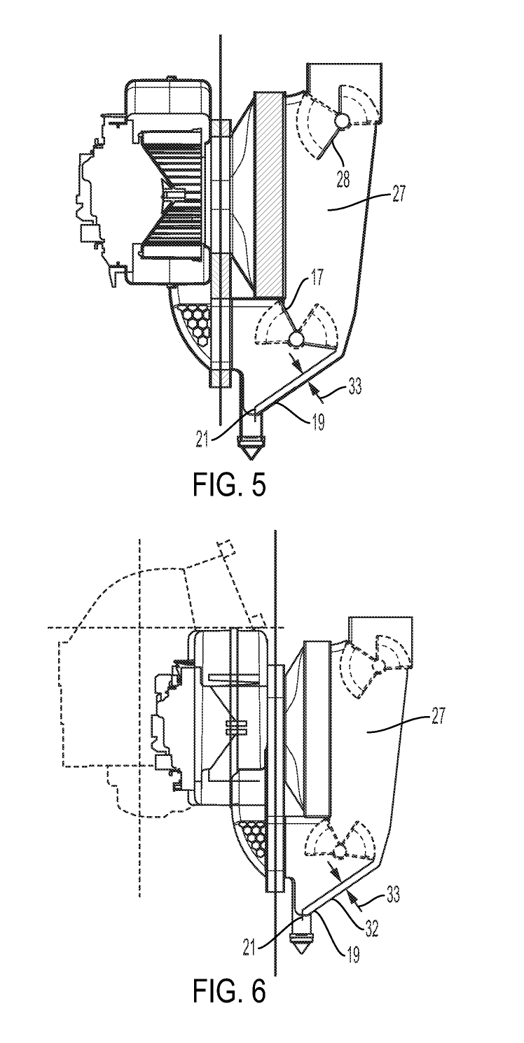

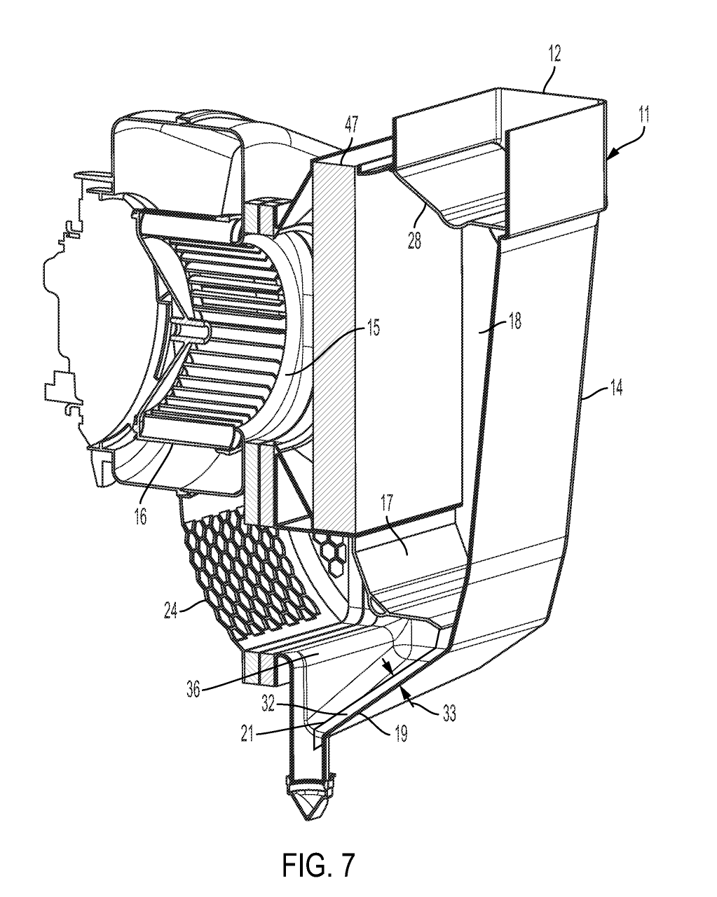

FIG. 5, FIG. 6, and FIG. 7 show various views of an example of the present disclosure. The recirculation door 17 and the fresh air door 28 are both shown in their respective closed positions in FIG. 7. In some examples of the present disclosure, the conduit 32 may be defined by an exterior wall 19 of the air intake housing 14 and an interior wall 21 located within a volume 27 enclosed by the air intake housing 14. As used herein, the “volume 27 enclosed by the air intake housing 14” means the volume surrounded by the air intake housing 14. The air intake housing 14 may have openings such that the air intake housing 14 does not completely enclose a volume; as disclosed herein, the volume enclosed by the air intake housing 14 is defined, in part, by an imaginary closure covering such an opening wherein the imaginary closure has the smallest possible surface area. An example of such an imaginary closure 42 is shown in FIG. 3. The volume 27 enclosed by the air intake housing 14 is also herein called the interior of the air intake housing 14. In examples having the conduit 32 defined by the exterior wall 19 of the air intake housing 14 and the interior wall 21 disclosed above, the interior wall 21 is spaced apart from the exterior wall 19 of the air intake housing 14. The space 33 between the exterior wall 19 of the air intake housing 14 and the interior wall 21 is large enough for water to flow through the space 33 and to prevent the water from collecting or pooling above the recirculation door 17. The interior wall 21 may be co-molded with the air intake housing 14. For example, the air intake housing 14 may be molded in at least 2 parts with a vertical joint (not shown). There may be a tongue and groove joint that is water tight at least along the portions of the interior wall 21 and the exterior wall 19 of the air intake housing 14 that define the conduit 32. A gasket (not shown) may be included in the joint. The joint may be welded, or separable. The joint may have adhesive or sealer applied, or no adhesive or sealer. The joint may include tabs, snaps, and/or fasteners.

The interior wall 21 may be attached to the air intake housing 14. For example, the interior wall 21 may be attached to the air intake housing with screws or other fasteners, by welding, adhesive, or by snap/interference fit. Stand-offs or spacers (not shown) may space the interior wall 21 from the exterior wall 19 of the air intake housing 14.

In some examples of the present disclosure, the conduit 32 may be a recirculation door bypass tube 30. (See, e.g., FIG. 2.) For example, the recirculation door bypass tube 30 may have a top opening 31 disposed in the recirculation airflow doorway 22, and an output opening 34 disposed in the sump portion 36. The recirculation door bypass tube 30 defines a path for the water to flow through or around the recirculation airflow doorway 22, to the sump portion 36. The sump portion 36 is to funnel the water to the drain 13.

In some examples, a normally closed check valve 29 may be in fluid communication with the drain 13 to open when water is present on an input side 35 of the normally closed check valve 29 (FIG. 2). The normally closed check valve 29 is closed except when water is present on the input side 35. When water is present on the input side 35 of the normally closed check valve 29, the normally closed check valve 29 opens (for example due to the weight of the water overcoming a spring) and the water flows through the normally closed check valve 29. In some examples, the water is allowed to return to the environment outside of the vehicle 60.

In some examples, the HVAC air intake 11 includes a screen 38 disposed in contact with the drain 13. The screen 38 may have screen openings 39 smaller than a minimum size, the screen 38 to hinder entry of objects and organisms through the drain 13 into the HVAC air intake 11 while allowing the water to flow out. In an example, the screen openings may be round and the minimum size may range from a diameter of about 0.1 mm to about 3 mm in diameter for each screen opening. The screen openings may be round, oval, rectangular, octagonal, or defined by any simple closed curve.

An HVAC system 10 for a vehicle 60 is also disclosed herein. In examples, the HVAC system 10 includes an HVAC module 70 having a heat exchanger disposed in an HVAC module housing 71 (FIG. 1). The HVAC module 70 is disposed in a passenger compartment 61 of the vehicle 60. The HVAC system 10 includes a blower 16 disposed in the HVAC module 70. The HVAC system 10 further includes an HVAC air intake 11 in fluid communication with the HVAC module 70. The HVAC air intake 11 includes an air intake housing 14 disposed outside of the passenger compartment 61 of the vehicle 60. The air intake housing 14 is connected to an intake side 15 of the blower 16. The HVAC air intake 11 includes a fresh air inlet 12 defined in an upper portion 18 of the air intake housing 14. The upper portion 18 of the air intake housing 14 means the portion of the air intake housing above the recirculation door 17 when the recirculation door 17 is in a closed position. The HVAC air intake 11 includes a drain 13 disposed in a sump portion 36 of the air intake housing 14 to drain water from the sump portion 36. As used herein, the sump portion 36 means the portion of the air intake housing below the recirculation door 17 when the recirculation door 17 is in a closed position.

In examples, the HVAC air intake 11 includes a recirculation door 17 disposed in a recirculation airflow doorway 22 defined in the air intake housing 14 below the fresh air inlet 12 and above the sump portion 36 to selectably open a recirculation airflow path 25 to selectably admit air from the passenger compartment 61 into the recirculation airflow path 25. The air in the HVAC air intake 11 is to flow to the intake side 15 of the blower 16 via the recirculation airflow path 25. The recirculation door 17 is to prevent air from flowing upwardly, and water from flowing downwardly, through the recirculation airflow doorway 22 when the recirculation door 17 is closed. The HVAC air intake 11 includes a conduit 32 disposed in the air intake housing 14 to convey water from the upper portion 18 of the air intake housing 14, around the recirculation door 17 to the sump portion 36 when the recirculation door 17 is closed.

In examples of the HVAC system 10 disclosed herein, the conduit 32 may be defined by an exterior wall 19 of the air intake housing 14 and an interior wall 21 located within a volume 27 enclosed by the air intake housing 14. The interior wall 21 may be spaced apart from the exterior wall 19. In other examples of the HVAC system disclosed herein, the conduit 32 may be a recirculation door bypass tube 30 as disclosed herein above.

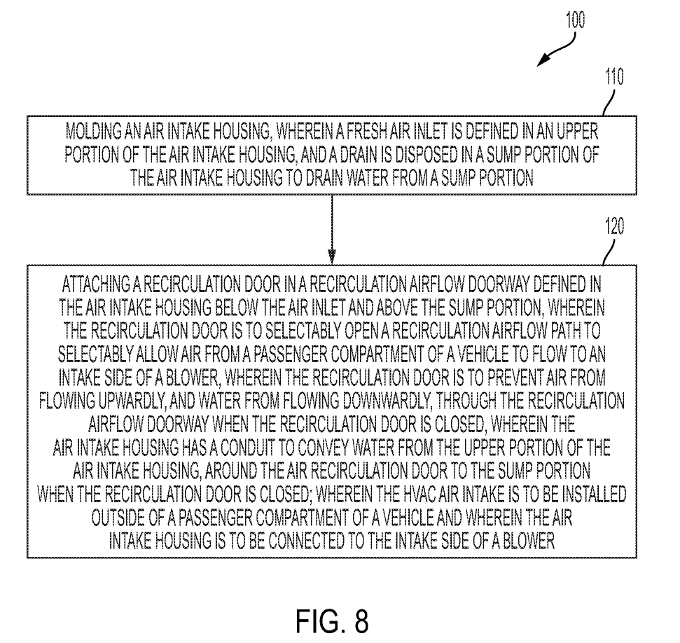

A method 100 of making an HVAC air intake 11 is also disclosed herein as depicted in FIG. 8. As depicted at Box 110, the method 100 includes molding an air intake housing 14, wherein a fresh air inlet 12 is defined in an upper portion 18 of the air intake housing 14. A drain 13 is disposed in the sump portion 36 of the air intake housing 14 to drain water from the sump portion 36.

As depicted at Box 120, the method 100 further includes attaching a recirculation door 17 in a recirculation airflow doorway 22 defined in the air intake housing 14 below the fresh air inlet 12 and above the sump portion 36, wherein the recirculation door 17 is to selectably open a recirculation airflow path 25 to selectably allow air from a passenger compartment 61 of a vehicle 60 to flow to an intake side 15 of a blower 16, wherein the recirculation door 17 is to prevent air from flowing upwardly, and water from flowing downwardly, through the recirculation airflow doorway 22 when the recirculation door 17 is closed, wherein the air intake housing 14 has a conduit 32 to convey water from the upper portion 18 of the air intake housing 14, around the recirculation door 17 to the sump portion when the recirculation door is closed; wherein the HVAC air intake is to be installed outside of the passenger compartment of the vehicle and wherein the air intake housing is to be connected to the intake side of a blower.

In examples, the method 100 may further include molding an interior wall 21 with an exterior wall 19 of the air intake housing 14, wherein the conduit 32 is defined by the exterior wall 19 of the air intake housing 14 and the interior wall 21, wherein the interior wall 21 is located within a volume 27 enclosed by the air intake housing 14, and wherein the interior wall 21 is spaced apart from the exterior wall 19.

In other examples, the method 100 may include attaching the conduit 32 to an interior 23 of the air intake housing 14 wherein the conduit 32 is a recirculation door bypass tube 30.

It is to be understood that the ranges provided herein include the stated range and any value or sub-range within the stated range. For example, a range from about 0.1 mm to about 3 mm should be interpreted to include not only the explicitly recited limits of from about 0.1 mm to about 3 mm, but also to include individual values, such as about 0.2 mm, about 0.5 mm, about 1.5 mm, about 2.52 mm, etc., and sub-ranges, such as from about 0.5 mm to about 1.8 mm, from about 1 mm to about 2.75 mm, etc. It is to be understood that when “about” is utilized to describe a value, this is meant to encompass minor variations (up to +/−10%) from the stated value.

Reference throughout the specification to “one example”, “another example”, “an example”, and so forth, means that a particular element (e.g., feature, structure, and/or characteristic) described in connection with the example is included in at least one example described herein, and may or may not be present in other examples. In addition, it is to be understood that the described elements for any example may be combined in any suitable manner in the various examples unless the context clearly dictates otherwise.

In describing and claiming the examples disclosed herein, the singular forms “a”, “an”, and “the” include plural referents unless the context clearly dictates otherwise.

The terms “connect/connected/connection”, “attach/attached/attachment” and/or the like are broadly defined herein to encompass a variety of divergent connected arrangements and assembly techniques. These arrangements and techniques include, but are not limited to (1) the direct communication between one component and another component with no intervening components therebetween; and (2) the communication of one component and another component with one or more components therebetween, provided that the one component being “connected to” or “attached to” the other component is somehow in communication with the other component (notwithstanding the presence of one or more additional components therebetween). Additionally, two components may be permanently, semi-permanently, or releasably engaged with and/or connected to one another.

It is to be further understood that “communication” is to be construed to include all forms of communication, including direct and indirect communication. Indirect communication may include communication between two components with additional component(s) located therebetween.

While several examples have been described in detail, it is to be understood that the disclosed examples may be modified. Therefore, the foregoing description is to be considered non-limiting.

What is claimed is:

1. An HVAC air intake for a vehicle, comprising:
an air intake housing disposed outside of a passenger compartment of the vehicle;
a fresh air inlet defined in an upper portion of the air intake housing;
a drain disposed in a sump portion of the air intake housing to drain water from the sump portion;
a recirculation door disposed in a recirculation airflow doorway defined in the air intake housing below the fresh air inlet and above the sump portion, wherein the recirculation door is to prevent air from flowing upwardly, and water from flowing downwardly, through the recirculation airflow doorway when the recirculation door is closed; and
a conduit disposed in the air intake housing to convey water from the upper portion of the air intake housing, around the recirculation door, to the sump portion when the recirculation door is closed.

2. The HVAC air intake as defined in claim 1 wherein the air intake housing is connected to an intake side of a blower.

3. The HVAC air intake as defined in claim 2 wherein the recirculation door is to selectably open a recirculation airflow path to selectably admit air from the passenger compartment into the recirculation airflow path, the air to flow to the intake side of the blower via the recirculation airflow path.

4. The HVAC air intake as defined in claim 1 wherein the conduit is defined by an exterior wall of the air intake housing and an interior wall located within a volume enclosed by the air intake housing, the interior wall being spaced apart from the exterior wall.

5. The HVAC air intake as defined in claim 4 wherein the interior wall is co-molded with the air intake housing.

6. The HVAC air intake as defined in claim 4 wherein the interior wall is attached to the air intake housing.

7. The HVAC air intake as defined in claim 1 wherein the conduit is a recirculation door bypass tube.

8. The HVAC air intake as defined in claim 1, further comprising a normally closed check valve in fluid communication with the drain to open when water is present on an input side of the normally closed check valve.

9. The HVAC air intake as defined in claim 1, further comprising a screen disposed in contact with the drain, wherein the screen has screen openings smaller than a minimum size, the screen to hinder entry of objects and organisms through the drain into the HVAC air intake.

10. An HVAC system for a vehicle, comprising:
an HVAC module having a heat exchanger disposed in an HVAC module housing, the HVAC module disposed in a passenger compartment of the vehicle;
a blower disposed in the HVAC module; and
an HVAC air intake in fluid communication with the HVAC module, the HVAC air intake including:
an air intake housing disposed outside of the passenger compartment of the vehicle, the air intake housing connected to an intake side of the blower;
a fresh air inlet defined in an upper portion of the air intake housing;
a drain disposed in a sump portion of the air intake housing to drain water from the sump portion;
a recirculation door disposed in a recirculation airflow doorway defined in the air intake housing below the fresh air inlet and above the sump portion to selectably open a recirculation airflow path to selectably admit air from the passenger compartment into the recirculation airflow path, the air to flow to the intake side of the blower via the recirculation airflow path, wherein the recirculation door is to prevent air from flowing upwardly, and water from flowing downwardly, through the recirculation airflow doorway when the recirculation door is closed; and
a conduit disposed in the air intake housing to convey water from the upper portion of the air intake housing, around the recirculation door to the sump portion when the recirculation door is closed.

11. The HVAC system as defined in claim 10 wherein the conduit is defined by an exterior wall of the air intake housing and an interior wall located within a volume enclosed by the air intake housing, the interior wall being spaced apart from the exterior wall.

12. The HVAC system as defined in claim 10 wherein the conduit is a recirculation door bypass tube.

13. A method of making an HVAC air intake, comprising:
molding an air intake housing, wherein a fresh air inlet is defined in an upper portion of the air intake housing, and a drain is disposed in a sump portion of the air intake housing to drain water from the sump portion; and
attaching a recirculation door in a recirculation airflow doorway defined in the air intake housing below the fresh air inlet and above the sump portion, wherein the recirculation door is to selectably open a recirculation airflow path to selectably allow air from a passenger compartment of a vehicle to flow to an intake side of a blower, wherein the recirculation door is to prevent air from flowing upwardly, and water from flowing downwardly, through the recirculation airflow doorway when the recirculation door is closed, wherein the air intake housing has a conduit to convey water from the upper portion of the air intake housing, around the recirculation door to the sump portion when the recirculation door is closed; wherein the HVAC air intake is to be installed outside of the passenger compartment of the vehicle and wherein the air intake housing is to be connected to the intake side of the blower.

14. The method as defined in claim 13, further comprising:
molding an interior wall with an exterior wall of the air intake housing, wherein the conduit is defined by the exterior wall of the air intake housing and the interior wall, wherein the interior wall is located within a volume enclosed by the air intake housing, and wherein the interior wall is spaced apart from the exterior wall.

15. The method as defined in claim 13, further comprising:
attaching the conduit to an interior of the air intake housing, wherein the conduit is a recirculation door bypass tube.
